(19) United States
(12) Patent Application Publication
(10) Pub. No.: US 2026/0175159 A1
(43) Pub. Date: Jun. 25, 2026

(54) AN AIR OR GAS TREATMENT SYSTEM COMPRISING A STRUCTURED ADSORBENT OR CATALYST IN THE FIRST PIPE

(71) Applicant: ATLAS COPCO AIRPOWER, NAAMLOZE VENNOOTSCHAP, Wilrijk (BE)

(72) Inventors: Tushar BHATT, Wilrijk (BE); Frank VAN PUYENBROECK, Wilrijk (BE); Julien COUSIN-SAINT-REMI, Wilrijk (BE); Carlo LAMMERS, Wilrijk (BE)

(73) Assignee: ATLAS COPCO AIRPOWER, NAAMLOZE VENNOOTSCHAP, Wilrijk (BE)

(21) Appl. No.: 19/126,058

(22) PCT Filed: Dec. 6, 2023
(86) PCT No.: PCT/IB2023/062301

§ 371 Date: Apr. 30, 2025

(30) Foreign Application Priority Data
Dec. 15, 2022 (BE) 2022/6018

(51) Int. Cl. B01D 53/047; B01D 53/02; B01D 53/04

(52) U.S. Cl. CPC B01D 53/047; B01D 53/02; B01D 53/04; B01D 53/0407; B01D 53/0423; B01D 53/0462

(57) ABSTRACT

An air or gas treatment system, including at least a vessel including at least a first aperture configured to receive and to release gas and at least a second aperture configured to release and to receive gas, the first and second apertures defining a passage between them, the passage having an inner cross-sectional area S_{V}, an adsorbent or catalyst placed in the passage, at least a first pipe fluidically connected to the first aperture of the vessel, the first pipe having an inner cross-sectional area S_{P} different from the inner cross-sectional area S_{V} of the vessel, and a structured adsorbent or catalyst in the first pipe.

### FIELD OF THE INVENTION

The field of the invention relates to an air or gas treatment system in the field of gas generation.

### DESCRIPTION OF RELATED ART

A known air or gas treatment system comprises a vessel containing an adsorbent or catalyst. A first pipe is connected to the first aperture of the vessel to supply gas to it for example during an adsorption process. For a smooth gas supply to the vessel the first pipe is kept empty.

In such a known layout, the volume of the first pipe is not utilized for gas treatment. Rather, its only purpose is to convey gas received and/or released by the vessel. This volume in the first pipes is typically called the dead volume.

### SUMMARY OF THE INVENTION

There is a need in the air or gas treatment system to improve the quality of gas supplied to the adsorbent vessel, for example; the dryer the supplied air, the better the performance of the adsorbent material. This is because if the adsorbent material inside the vessel is used to adsorb moisture in the supplied air as well, the adsorbent material loses a part of its capacity to adsorb other gaseous components which one actually wishes to be adsorbed by the adsorbent material.

Some embodiments of the present disclosure relate to an air or gas treatment system that reduces the unutilized dead volume. Some embodiments of the present disclosure relate to an air or gas treatment system that provides gas of a better quality to the vessel containing adsorbent material.

One aspect of this disclosure relates to an air or gas treatment system comprising at least a vessel comprising at least a first aperture configured to receive and to release gas and, at least a second aperture configured to release and to receive gas. The first and second apertures define a passage between them, the passage having an inner cross-sectional area S_{V}. The air or gas treatment system also comprises an adsorbent or catalyst placed in the passage. The adsorbent or catalyst is configured to adsorb or trap at least partially at least one component of gas received by the adsorbent or catalyst such that, the gas released from the adsorbent or catalyst has an outgoing composition different from an incoming composition of gas received by the adsorbent or catalyst. The air or gas treatment system also comprises at least a first pipe fluidically connected to the first aperture of the vessel. The first pipe has an inner cross-sectional area S_{P} different from the inner cross-sectional area S_{V} of the vessel. The air or gas treatment system also comprises a structured adsorbent or catalyst in the first pipe. The structured adsorbent or catalyst is configured to adsorb or trap at least partially at least one component of gas received by the structured adsorbent or catalyst such that, the gas released from the structured adsorbent or catalyst has an outgoing composition different from an incoming composition of gas received by the structured adsorbent or catalyst.

By placing a structured adsorbent in the first pipe, the dead volume in the first pipe is reduced. At the same time, the dead volume is put to good use by the structured adsorbent or catalyst. The structured adsorbent adsorbs at least partially at least one gaseous component that is not desirable for the adsorbent material in the vessel. The structured catalyst reacts chemically at least with one component of gas received in the first pipe. This can in turn increase the efficiency of the adsorbent material or catalyst in the vessel.

The air or gas treatment system may comprise one or more of the following features taken individually or according to any technically possible combinations:

The cross-sectional area S_{P} of the first pipe is strictly smaller than the cross-sectional area S_{V} of the vessel.

This feature means that the structured adsorbent is placed outside the vessel.

At least one of the structured adsorbent or catalyst consists of a single block or several blocks.

When a structured adsorbent or catalyst consists of several blocks it gives the structured adsorbent or catalyst the maintenance flexibility: if a block of the structured adsorbent becomes less effective, it is necessary to replace only that block of the structured adsorbent instead of all the blocks. When a structured adsorbent or catalyst consists of a single block, it simplifies the installation and maintenance of this single block adsorbent or catalyst.

At least one of the structured adsorbent or catalyst comprises channels having surfaces, the surfaces of the channels being configured to be in direct contact with the gas passing through the structured adsorbent or catalyst, at least a portion of the surfaces of the channels having an adsorbent or catalyst layer.

This feature saves material which performs the adsorbing function in the structured adsorbent: instead of making the entire structured adsorbent from an adsorbing material, only part of the contact surface of the structured adsorbent needs to have the adsorbing material. The channels increase the size of the contact surface between gas and the adsorbent material.

The structured adsorbent or catalyst in the first pipe is configured to adsorb or trap at least partially moisture and/or CO₂.

If the adsorbent or catalyst in the vessel has to adsorb moisture and/or CO₂ in addition to the intended gas component (such as oxygen and/or nitrogen), a smaller amount of the adsorbent or catalyst in the vessel will be available to adsorb the intended gas component. In this way, the effectiveness of the adsorbent or catalyst in the vessel may be reduced. With the structured adsorbent or catalyst adsorbing or trapping at least partially moisture and/or CO₂, the adsorbent or catalyst in the vessel can focus on adsorbing or trapping the intended gaseous component, thus increasing the effectiveness of the vessel.

The structured adsorbent or catalyst in the first pipe is configured to desorb when the first pipe has a pressure between 0.1 bar absolute to 10 bar absolute and/or a temperature between 30° C. to 500° C.

The first pipe is intended to feed gas to the vessel during an adsorption process and to receive exhaust from the vessel during a desorption process. The air or gas treatment system further comprises at least a feed pipe and a feed pipe structured adsorbent or catalyst in the feed pipe. The feed pipe being intended to feed gas to the first pipe during an adsorption process and to be kept clear of exhaust during a desorption process. The feed pipe structured adsorbent or catalyst being configured to adsorb or trap at least partially at least one component of gas received by the feed pipe structured adsorbent or catalyst such that gas released from the feed pipe structured adsorbent or catalyst has an outgoing composition different from an incoming composition of the gas received by the feed pipe structured adsorbent or catalyst.

During an adsorption process gas flows through the feed pipe and the first pipe before entering the vessel. By having a feed pipe structured adsorbent or catalyst separate from the structured adsorbent or catalyst in the first pipe, the quality of gas entering the vessel during an adsorption process can be further improved. The feed pipe structured adsorbent or catalyst can for example adsorb a gas component that degrades the performance of the structured adsorbent or catalyst in the first pipe, and/or degrades the performance of the adsorbent or catalyst in the vessel. In this way, the adsorbent material and/or the structured adsorbent can be more effective.

The feed pipe structured adsorbent or catalyst is configured to adsorb or trap trace contaminants (at least one chosen from sulphur dioxide, hydrogen chloride, nitrous oxide, ozone, hydrocarbons, volatile organic compounds, NOx, dust, radioactive rare gases, and ammonia).

The feed pipe structured adsorbent or catalyst is configured to adsorb or trap gas components different from those adsorbed or trapped by the structured adsorbent or catalyst in the first pipe. In this way, the feed pipe structured adsorbent or catalyst can reduce the amount of gaseous components that are detrimental to the performance of the structured adsorbent or catalyst in the first pipe. Indeed, the contaminants listed above typically degrade the performance of the adsorbent material in the vessel: if the adsorbent material needs to adsorb these contaminants as well, it will have less capacity to adsorb its main target gaseous component, typically oxygen or nitrogen. With the structured adsorbents adsorbing these contaminants before the feed gas mixture enters the vessel, the structured adsorbents enhance the performance of the adsorbent material in the vessel.

The pressure drop across the structured adsorbent or catalyst in the first pipe and/or the feed pipe structured adsorbent or catalyst is lower than 500 mbar absolute, preferably lower than 200 mbar absolute, more preferably lower than 50 mbar absolute, even more preferably lower than 10 mbar absolute.

It is desirable to have this pressure drop as low as possible. The structured adsorbent in the first pipe and/or the feed pipe structured adsorbent or catalyst according to this feature only causes minor pressure drop, thereby minimizing energy loss.

The structured adsorbent or catalyst occupies the entire cross section of the first pipe and/or the feed pipe structured adsorbent or catalyst occupies the entire cross section of the feed pipe.

Under this embodiment, gas going through the first pipe passes necessarily through the structured adsorbent or catalyst, and/or gas going through the feed pipe passes necessarily through the feed pipe structured adsorbent or catalyst. This increases the possibility that the structured adsorbent or catalyst in the first pipe and/or the feed pipe structured adsorbent or catalyst can react with a gaseous component present in the gas passing through it.

The structured adsorbent or catalyst in the first pipe and/or the feed pipe structured adsorbent or catalyst consist of an active adsorbent material directly extruded in the required structural form, or has a film of active adsorbent material deposited or grown on a surface of a support structure.

The structured adsorbent or catalyst thus obtained does not require additional cutting or shaping of the support before it can be placed inside the first pipe and/or the feed pipe.

The active adsorbent material comprises at least one of the following: metal-organic frameworks, carbon materials (such as activated carbon, carbon molecular sieves, carbon fibres), resins and polymers, clays, silica gel, activated alumina, natural or synthetic zeolites (types A, X, Y, mordenite, silicalite, chabazite, faujasite, clinoptilolite, and their ion-exchanged varieties: KA, 3A, 4A, 5A, 10A, Si-CHA, ITQ, ZSM, 13X, LiX, CaX, CA-LSX, Li-LSX, NaX, CaA).

The structured adsorbent or catalyst can be in the form of foams, fabric, monoliths, or laminates.

The support material of structured adsorbent or catalyst in the first pipe and/or the feed pipe structured adsorbent or catalyst can comprise: corrugated paper or honeycomb structure, or paper monolith, or cordierite monolith, or honeycomb monolith, or honeycomb rotary adsorber, or activated carbon cloth, or charcoal cloth, or self-supporting adsorbent fabric, or multi-layered adsorbent fabric, or paper honeycomb, or copper foam, or ceramic foam, or parallel passage laminate, or adsorbent laminate, or spirally wound laminate, or activated carbon honeycomb monolith, or polyamide monolith, or carbon monolith, or monolithic wheel, or ceramic monolith, or zeolite monolith, or metal monolith, or inherent adsorbent monolith, or inherent adsorbent honeycomb monolith, or inherent adsorbent foam, or inherent adsorbent cloth.

The first pipe and/or the feed pipe has a diameter between 9 mm and 2000 mm.

The adsorbent or catalyst in the vessel is in the form of beads, pellets, foams, fabric, monoliths, or laminates.

The adsorbent or catalyst in the vessel comprises at least one layer of: metal-organic frameworks or, carbon materials (such as activated carbon, carbon molecular sieves, carbon fibres) or, resins and polymers or, clays or, silica gel or, activated alumina or, natural or synthetic zeolites (types A, X, Y, mordenite, silicalite, chabazite, faujasite, clinoptilolite, and their ion-exchanged varieties: KA, 3A, 4A, 5A, 10A, Si-CHA, ITQ, ZSM, 13X, LiX, CaX, CA-LSX, Li-LSX, NaX, CaA).

The adsorbent or catalyst in the vessel adsorbs or traps at least partially carbon dioxide and/or moisture and/or nitrogen and/or oxygen and/or argon and/or hydrogen and/or hydrogen sulphide and/or mercaptans and/or paraffins, and/or acid gases, and/or silanes, and/or mercury vapor, and/or hydrocarbons, and/or trace contaminants in air or gas (sulphur dioxide, hydrogen chloride, nitrous oxide, ozone, hydrocarbons, volatile organic compounds, NOx, dust, radioactive rare gases, ammonia).

The vessel is configured to receive gas having a pressure between 1.1 bar absolute and 30 bar absolute.

The passage has a diameter between 49 mm and 3000 mm.

The gas released and/or received by the vessel has a flux between 0.1Nm 3 /h and 16000 Nm³/h.

### BRIEF DESCRIPTION OF THE DRAWINGS

The above and further aspects of the disclosure will be explained in more detail below on the basis of a number of embodiments, which will be described with reference to the appended drawings. In the drawings:

FIG. 1 shows a gas generator in the prior art;

FIG. 2 shows a gas generator according to an embodiment of the present disclosure, the first pipe comprising a structured adsorbent or catalyst;

FIG. 3 shows a gas generator similar to the one in FIG. 2, further comprising a feed pipe structured adsorbent or catalyst in the feed pipe.

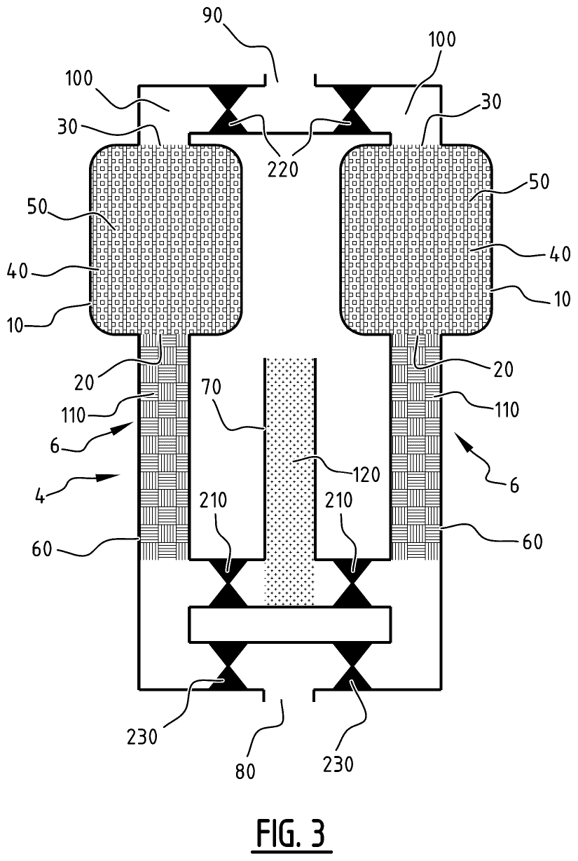

### DESCRIPTION OF THE INVENTION

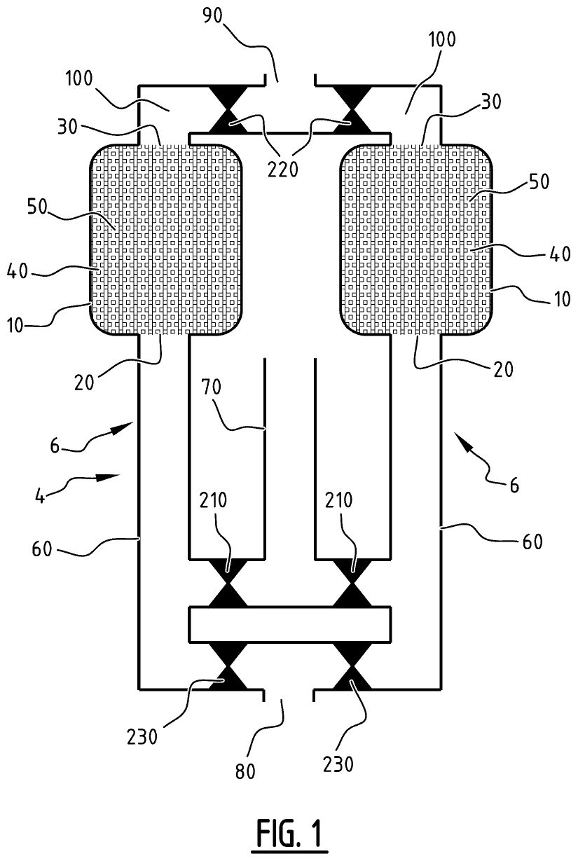

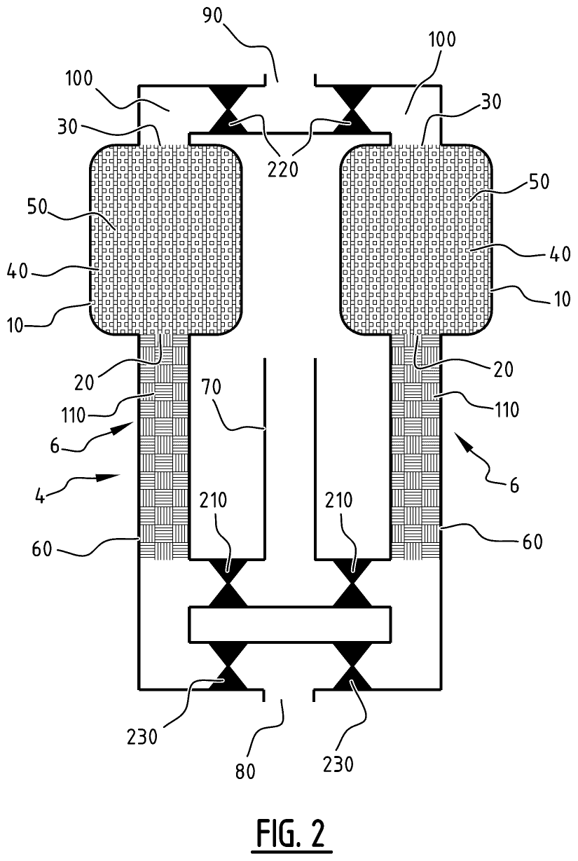

A gas generator 4 is shown in the FIGS. 1, 2 and, 3. The gas generator 4 is for example configured to process atmospheric air and generate a specific gas or gaseous mixture.

The air or gas treatment system 4 is for example an oxygen or a nitrogen generator, or an air or gas dryer, or a desulfurization unit, or a solvent vapor recovery unit, or a silanes removal unit, or a trace radioactive rare gases removal unit, or a mercury vapor trapping unit, or a deodorizing and air freshening unit, or a trace ammonia removal unit, or a hydrogen production unit, or a gas separator, or an alcohol dehydrator, or a gas chromatograph, or a carbon dioxide and/or hydrogen sulphide and/or methane and/or ethane removal unit configured to remove at least parts of components from received gas.

The gas generator 4 comprises at least one air or gas treatment system 6. According to some embodiments such as shown in the Figures, the gas generator 4 comprises at least two air or gas treatment systems 6.

The air or gas treatment system 6 comprises at least a vessel 10. The vessel 10 comprises at least a first aperture 20 and at least a second aperture 30. The air or gas treatment system 6 also comprises at least a first pipe 60 fluidically connected to the first aperture 20 of the vessel 10 and at least one second pipe 100 fluidically connected to the second aperture 30 of the vessel 10. The air or gas treatment system 6 also comprises a structured adsorbent or catalyst 110 in the first pipe 60.

The vessel 10 is typically used in a pressure swing adsorption process. A co-current flow typically enters the vessel 10 by the first aperture 20 and leaves the vessel via the second aperture 30. In this case, the first aperture 20 is configured to receive gas with an incoming gaseous composition, and the second aperture 30 is configured to release gas having an outgoing gaseous composition. A counter current flow typically enters the vessel 10 via the second aperture 30 and leaves the vessel 10 via the first aperture 20. In this case, the second aperture 30 is configured to receive gas with an incoming gaseous composition, and the first aperture 20 is configured to release gas having an outgoing gaseous composition. The first aperture 20 is for example located at the bottom of the vessel 10. The second aperture 30 is for example located on the top of the vessel 10.

In the description that follows, unless indicated otherwise, the first aperture 20 corresponds to the inlet of a co-current flow into the vessel 10. The vessel 10 has a co-current flow when it operates in the adsorption mode. The second aperture 30 corresponds to the outlet of a co-current flow out of the vessel 10. Consequently, the first aperture 20 is the outlet of a counter current flow out of the vessel 10. The vessel 10 has a counter current flow when it operates in the desorption mode. The second aperture 30 corresponds then to the inlet of a counter current flow into the vessel 10.

Where the air or gas treatment system 6 is configured to generate oxygen, preferably the outgoing gas from the second aperture 30 during an adsorption process majorly comprises of oxygen. When the air or gas treatment system 6 is configured to generate nitrogen, preferably the outgoing gas from the second aperture 30 during an adsorption process majorly comprises of nitrogen.

The vessel 10 comprises a passage 40 between the first aperture 20 and second aperture 30. The passage 40 is configured to allow gas flows between the first and second apertures 20, 30. The passage 40 has an inner cross-sectional area S_{V}. The passage 40 for example has a diameter between 49 mm and 3000 mm.

The vessel 10 comprises an adsorbent or catalyst 50 placed in the passage 40 of the vessel 10. The adsorbent or catalyst 50 is configured to adsorb or trap at least partially at least one component of gas received by the adsorbent or catalyst 50 such that gas released from the adsorbent or catalyst 50 has an outgoing composition different from an incoming composition of gas received by the adsorbent or catalyst 50.

According to some embodiments the adsorbent or catalyst 50 in the vessel 10 is in the form of beads, pellets, foams, fabric, monoliths, or laminates.

According to some embodiments the adsorbent or catalyst 50 in the vessel 10 comprises at least one layers of: metal-organic frameworks or, carbon materials (such as activated carbon, carbon molecular sieves, carbon fibres) or, resins and polymers or, clays or, silica gel or, activated alumina or, natural or synthetic zeolites (types A, X, Y, mordenite, silicalite, chabazite, faujasite, clinoptilolite, and their ion-exchanged varieties: KA, 3A, 4A, 5A, 10A, Si-CHA, ITQ, ZSM, 13X, LiX, CaX, CA-LSX, Li-LSX, NaX, CaA). According to some embodiments the adsorbent or catalyst 50 in the vessel 10 comprises at least two layers of the materials (of the same or different types) mentioned in this paragraph.

According to some embodiments, the adsorbent or catalyst 50 in the vessel 10 adsorbs or traps at least partially: carbon dioxide and/or moisture and/or nitrogen and/or oxygen and/or argon and/or hydrogen and/or hydrogen sulphide and/or mercaptans and/or paraffins, and/or acid gases, and/or silanes, and/or mercury vapor, and/or hydrocarbons, and/or trace contaminants in air or gas (sulphur dioxide, hydrogen chloride, nitrous oxide, ozone, hydrocarbons, volatile organic compounds, NOx, dust, radioactive rare gases, ammonia).

According to one embodiment, the first pipe 60 has an inner cross-sectional area S_{P} different from the inner cross-sectional area S_{V} of the passage 40 of the vessel 10. According to one embodiment, the cross-sectional area S_{P} of the first pipe 60 is strictly smaller than the cross-sectional area S_{V} of the passage 40 of the vessel 10, preferably at least 20% smaller, more preferably at least 30% smaller. This clarifies that the structured adsorbent or catalyst 110 (in the first pipe) is not located in the vessel 10 but located outside the vessel 10.

The first pipe 60 is for example connected to the first aperture 20 of the vessel 10. The first pipe 60 is intended to feed gas to the vessel 10 during an adsorption process and to receive exhaust from the vessel 10 during a desorption process.

According to the embodiments shown in the Figures, the structured adsorbent or catalyst 110 is in the first pipe 60. Preferably there is no structured adsorbent in the second pipe 100.

The structured adsorbent or catalyst 110 is configured to adsorb or trap at least partially at least one component of gas received by the structured adsorbent or catalyst 110 such that gas released from the structured adsorbent or catalyst 110 has an outgoing composition different from an incoming composition of gas received by the structured adsorbent or catalyst 110. The structured adsorbent or catalyst 110 is for example configured to adsorb at least 25%, preferably 50%, more preferably 60%, even more preferably 75%, even more preferably 80%, even more preferably 90%, even more preferably 95%, even more preferably 99%, of at least one component of a mixture received by the structured adsorbent or catalyst 110.

According to one embodiment, the structured adsorbent or catalyst 110 consists of a single block or several blocks. When the structured adsorbent or catalyst 110 comprises several blocks, these multiple blocks are for example placed next to each other along the flow direction in the first pipe 60. When the structured adsorbent or catalyst 110 comprises several blocks, according to some embodiments, the air or gas treatment system 6 comprises at least one spacing seal (not depicted in the Figures) placed between two blocks of the structured adsorbent or catalyst 110 in the flow direction of the first pipe 60.

According to some embodiments, the structured adsorbent or catalyst 110 in the first pipe 60 is configured to adsorb or trap at least partially, moisture and/or CO₂.

According to some embodiments, the structured adsorbent or catalyst 110 in the first pipe 60 is configured to desorb when the first pipe 60 has a pressure between 0.1 bar absolute to 10 bar absolute and/or a temperature between 30° C. to 500° C.

One of the advantages of using the structured adsorbent or catalyst 110 is that the pressure drop across it is relatively low. In particular, the pressure drop across the structured adsorbent or catalyst 110 is smaller compared to that across a block of the same dimension in the flow direction comprising adsorbent beads. According to some embodiments, the pressure drop across the vessel 10 is at least 10 times higher than that across the structured adsorbent or catalyst 110.

According to some embodiments, the adsorbent or catalyst 50 and the structured adsorbent or catalyst 110 comprise different adsorbent compositions and/or configured to adsorb different gaseous component(s). For example, the structured adsorbent or catalyst 110 is configured to adsorb moisture, and/or CO₂, and/or dust, and/or trace impurities in ambient air (NOₓ, SO₂, HCl, O₃, N₂O), and/or hydrocarbons, while the adsorbing material 50 is configured to adsorb nitrogen and/or oxygen.

According to some embodiments, the adsorbent or catalyst 50 and the structured adsorbent or catalyst 110 comprise the same material or substantially the same adsorbent composition, and/or configured to adsorb the same substance. For example, where the adsorbent or catalyst 50 in the vessel 10 comprises three layers of LiX beads, silica gel, and 13X beads, the structured adsorbent or catalyst 110 comprises structured structured 13X.

According to some embodiments, the structured adsorbent or catalyst 110 comprises channels having surfaces. The channels may be straight or meandering. At least a portion of the surfaces of the channels has a coating of an adsorbent or catalyst layer. The surfaces of the channels are configured to be in direct contact with the gas passing through the structured adsorbent or catalyst 110. The coating for example, comprises molecular sieves (for example made from adsorbent beads crushed into powder) such as 13X or CMS (carbon molecular sieves).

According to one possibility the support of the structured adsorbent or catalyst 110 is made of ceramic or polyamide-according to one embodiment, the support structure is made of ceramic with a coating of molecular sieve as described above; according to one embodiment, the support structure is made of polyamide with a coating of activated carbon.

In addition or as an alternative, the support of the structured adsorbent or catalyst 110 comprises sheets on which the adsorbent layer is coated. The sheets are for example wrapped or rolled. The sheets are for example made of polymer.

According to some embodiments, the structured adsorbent or catalyst 110 consists of an inherent adsorbent in its entirety.

According to one embodiment, the structured adsorbent or catalyst 110 has a honeycomb structure. This is for example the case where the structured adsorbent or catalyst 110 consists of an inherent adsorbent in its entirety. This can also be the case where the structured adsorbent or catalyst 110 comprises a contact surface configured to be in direct contact with gas, at least a portion of the contact surface being coated with an adsorbent layer.

According to some embodiments, the air or gas treatment system 4 further comprises at least a feed pipe 70. The feed pipe 70 is fluidically connected to the first pipe 60. The feed pipe 70 is connected to a gas source, for example from an air compressor. The feed pipe 70 is intended to feed gas to the first pipe 60 during an adsorption process and to be kept clear of exhaust during a desorption process. According to the embodiments shown in the Figures, the first pipe 60 connects the first aperture 20 of the vessel 10 to the feed pipe 70. According to some embodiments, the first pipe 60 and/or the feed pipe 70 has a diameter between 9 mm and 2000 mm. According to some embodiments, the feed pipe 70 has the same cross-sectional area as the first pipe 60. According to some embodiments, the cross-sectional area of the feed pipe 70 is strictly smaller than the cross-sectional area S_{V} of the vessel 10.

According to some embodiments, the air or gas treatment system 4 further comprises a feed pipe structured adsorbent or catalyst 120 in the feed pipe 70. The feed pipe structured adsorbent or catalyst 120 is configured to adsorb or trap at least partially at least one component of gas received by the feed pipe structured adsorbent or catalyst 120 such that gas released from the feed pipe structured adsorbent or catalyst 120 has an outgoing composition different from an incoming composition of the gas received by the feed pipe structured adsorbent or catalyst 120. According to some embodiments, the feed pipe 70 is configured such that a feed gas mixture entering at least one vessel 10 passes necessarily through at least part of the feed pipe structured adsorbent or catalyst 120 before entering the first pipe 60.

According to one embodiment, the feed pipe structured adsorbent or catalyst 120 is configured to adsorb or trap trace contaminants (at least one chosen from sulphur dioxide, hydrogen chloride, nitrous oxide, ozone, hydrocarbons, volatile organic compounds, NOx, dust, radioactive rare gases, and ammonia). This embodiment for example, corresponds to an embodiment disclosed above where the structured adsorbent or catalyst 110 in the first pipe 60 is configured to adsorb or trap at least partially moisture and/or CO2.

Preferably the structured adsorbent or catalyst 110 comprises a synthetic zeolite of the type 13X for example configured to adsorb moisture and CO₂, and the feed pipe structured adsorbent or catalyst 120 comprises activated carbon for example configured to adsorb hydrocarbons.

According to some embodiments, the structured adsorbent or catalyst 110 is regenerated when the adsorbent 50 (in the vessel 10) is regenerated during the desorption process. According to some embodiments, the feed pipe structured adsorbent or catalyst 120 is never regenerated. The feed pipe structured adsorbent or catalyst 120, for example, is discarded (and replaced by a new one) after its adsorption capacity is exhausted. This for example is assessed via the operating hours of the gas generator.

According to some embodiments, the feed pipe structured adsorbent or catalyst 120 is configured to adsorb or trap gas components different from those adsorbed or trapped by the structured adsorbent or catalyst 110 and/or the adsorbent 50 (in the vessel 10). As an alternative, at least one gas component is adsorbed or trapped both by the feed pipe structured adsorbent or catalyst 120 and by the structured adsorbent or catalyst 110 in the first pipe 60.

According to some embodiments, the gas generator 4 comprises at least one desorption exhaust pipe 80, as visible in the Figures. The desorption exhaust pipe 80 is configured to receive exhaust gas, for example from the vessel 10, during a desorption process. The desorption exhaust pipe 80 for example receives exhaust gas from the vessel 10 via the first pipe 60.

Preferably, only the exhaust gas (released during the desorption process) flows through the desorption exhaust pipe 80.

According to an advantageous embodiment, the air or gas treatment system 6 comprises at least one circumferential seal (not represented in the Figures) configured to surround at least part of the external surface of the structured adsorbent or catalyst 110. The circumferential seal is configured to fill in the space between the external surface of the structured adsorbent or catalyst 110 and the internal surface of the first pipe 60. The circumferential seal prevents the structured adsorbent or catalyst 110 from bumping against the wall of the first pipe 60. This can prevent the attrition of the structured adsorbent or catalyst 110. In addition or as an alternative, the circumferential seal limits the free path of the gas so that the gas passing through the first pipe 60 necessarily passes through the structured adsorbent or catalyst 110.

The circumferential seal is for example made of rubber.

According to some embodiments, the structured adsorbent or catalyst 110 occupies the entire cross-section of the first pipe 60 and/or the feed pipe structured adsorbent or catalyst 120 occupies the entire cross-section of the feed pipe 70.

According to some embodiments, out of the two adsorbent vessels 10 depicted in the Figures, when one of the vessels 10 is undergoing the adsorption process, the other vessel 10 is undergoing the desorption process.

According to some embodiments, as shown in the Figures the gas generator 4 comprises a feed valve 210 between at least a first pipe 60 and a feed pipe 70. Preferably the gas generator 4 comprises a feed valve 210 between each group of the first pipe 60 and the feed pipe 70. When the feed valve 210 is open, gas can flow from the feed pipe 70 to the first pipe 60. When the feed valve 210 is closed, gas is prevented from flowing between the first pipe 60 and the feed pipe 70. According to some embodiments the feed valve 210 separates the feed pipe 70 from the rest of the gas generator 4.

According to some embodiments, the gas generator 4 comprises at least a second pipe valve 220 in at least a second pipe 100. Preferably, the gas generator 4 comprises a second pipe valve 220 in each second pipe 100. When the second pipe valve 220 is open, gas can flow through the second pipe 100, for example from the second aperture 30 to the adsorption product end 90, during an adsorption process where the second pipe 100 receives produced gas. When the second pipe valve 220 is closed, gas is prevented from flowing through the second pipe 100. According to some embodiments, the second pipe valve 220 separates the adsorption product end 90 from the rest of the gas generator 4.

According to some embodiments, the gas generator 4 comprises an exhaust valve 230 between at least a first pipe 60 and the desorption exhaust pipe 80. Preferably the gas generator 4 comprises an exhaust valve 230 between each group of the first pipe 60 and the desorption exhaust pipe 80. When the exhaust valve 230 is open, gas can flow from the first pipe 60 to the desorption exhaust pipe 80. When the exhaust valve 230 is closed, gas is prevented from flowing between the first pipe 60 and the desorption exhaust pipe 80. According to some embodiments, the exhaust valve 230 separates the desorption exhaust pipe 80 from the rest of the gas generator 4.

According to some embodiments, during the adsorption process, the feed valve 210 and the second pipe valve 220 is open while the exhaust valve 230 is closed. In this way, during the adsorption process, gas can flow from the feed pipe 70 through the first pipe 60 to reach the vessel 10. After passing through the vessel 10 product gas passes through the second pipe 100 before leaving the gas generator 4 via the adsorption product end 90. Because the exhaust valve 230 is closed, no gas will flow from the feed pipe 70 and/or from the first pipe 60 to the desorption exhaust pipe 80.

According to some embodiments, during the desorption process, the feed valve 210 is closed while the second pipe valve 220 and the exhaust valve 230 are open. In this way, during the desorption process, purge gas can flow through the second pipe 100 to enter the vessel 10 through the second aperture 30. Exhaust gas exits the vessel 10 via the desorption exhaust pipe 80. Because the feed valve 210 is closed, no gas will flow from the first pipe 60 to the feed pipe 70.

According to some embodiments, when the pressure in both vessels 10 need to be equalized, the feed valves 210 and the exhaust valves 230 are closed while the second pipe valves 220 in two different second pipes 100 are opened. This way, the gas flows through the second pipes 100 (from a high pressure vessel to a low pressure vessel) until the pressure in both vessels 10 is equalized. Note that, no product gas will be generated during this equalization phase.

According to some embodiments, when gas flows through the structured adsorbent or catalyst 110 and/or the feed pipe structured adsorbent or catalyst 120, the resulting pressure drop is lower than 500 mbar absolute, preferably lower than 200 mbar absolute, more preferably lower than 50 mbar absolute, even more preferably lower than 10 mbar absolute.

According to some embodiments the structured adsorbent or catalyst 110 and/or the feed pipe structured adsorbent or catalyst 120 consists of an active adsorbent material directly extruded in the required structural form or, has a film of active adsorbent material deposited or grown on a support, for example by at least one of the following methods: dip-coating, or slip-coating, or wash-coating, or a film grown on the required structural form by a hydrothermal treatment. Under one possibility, the active adsorbent material 50, 110, 120 comprises at least one of the following:
metal-organic frameworks, carbon materials (such as activated carbon, carbon molecular sieves, carbon fibres), resins and polymers, clays, silica gel, activated alumina, natural or synthetic zeolites (types A, X, Y, mordenite, silicalite, chabazite, faujasite, clinoptilolite, and their ion-exchanged varieties: KA, 3A, 4A, 5A, 10A, Si-CHA, ITQ, ZSM, 13X, LiX, CaX, CA-LSX, Li-LSX, NaX, CaA).

According to some embodiments, the structured adsorbent or catalyst 110 has a cylindrical shape matching the shape of the first pipe 60. According to some embodiments, the cross-section of the first pipe 60 and/or the feed pipe 70 is cylindrical.

According to some embodiments, the structured adsorbent or catalyst 110, 120 is the form of foams, fabric, monoliths, or laminates.

According to some embodiments, the structured adsorbent or catalyst 110 and/or the feed pipe structured adsorbent or catalyst 120 comprises a support (not shown in the Figures) comprising corrugated paper or honeycomb structure, or paper monolith, or cordierite monolith, or honeycomb monolith, or honeycomb rotary adsorber, or activated carbon cloth, or charcoal cloth, or self-supporting adsorbent fabric, or multi-layered adsorbent fabric, or paper honeycomb, or copper foam, or ceramic foam, or parallel passage laminate, or adsorbent laminate, or spirally wound laminate, or activated carbon honeycomb monolith, or polyamide monolith, or carbon monolith, or monolithic wheel, or ceramic monolith, or zeolite monolith, or metal monolith, or inherent adsorbent monolith, or inherent adsorbent honeycomb monolith, or inherent adsorbent foam, or inherent adsorbent cloth.

According to some embodiments, the vessel 10 is configured to receive gas having a pressure between 1.1 bar absolute and 30 bar absolute, preferably between 2 bar absolute and 16 bar absolute.

According to some embodiments, the gas released and/or received by the vessel 10 has a flux between 0.1Nm³/h and 16000 Nm³/h.

21. (canceled)

22. An air or gas treatment system, comprising:
at least a vessel comprising at least a first aperture configured to receive and to release gas and at least a second aperture configured to release and to receive gas, the first and second apertures defining a passage between them, the passage having an inner cross-sectional area S_{V},
an adsorbent or catalyst placed in the passage, the adsorbent or catalyst being configured to adsorb or trap at least partially at least one component of gas received by the adsorbent or catalyst such that gas released from the adsorbent or catalyst has an outgoing composition different from an incoming composition of gas received by the adsorbent or catalyst,
at least a first pipe fluidically connected to the first aperture of the vessel, the first pipe having an inner cross-sectional area S_{P} different from the inner cross-sectional area S_{V} of the vessel, and
a structured adsorbent or catalyst in the first pipe, the structured adsorbent or catalyst being configured to adsorb or trap at least partially at least one component of gas received by the structured adsorbent or catalyst such that, gas released from the structured adsorbent or catalyst has an outgoing composition different from an incoming composition of gas received by the structured adsorbent or catalyst.

23. The air or gas treatment system according to claim 22, wherein the cross-sectional area S_{P} of the first pipe is strictly smaller than the cross-sectional area S_{V} of the vessel.

24. The air or gas treatment system according to claim 22, wherein, at least one of the structured adsorbent or catalyst consists of a single block or several blocks.

25. The air or gas treatment system according to claim 22, wherein, at least one of the structured adsorbent or catalyst comprises channels having surfaces, the surfaces of the channels being configured to be in direct contact with the gas passing through the structured adsorbent or catalyst, at least a portion of the surfaces of the channels having an adsorbent or catalyst layer.

26. The air or gas treatment system according to claim 22, wherein, the structured adsorbent or catalyst in the first pipe is configured to adsorb or trap at least partially moisture and/or CO₂.

27. The air or gas treatment system according to claim 22, wherein, the structured adsorbent or catalyst in the first pipe is configured to desorb when the first pipe has a pressure between 0.1 bar absolute to 10 bar absolute and/or a temperature between 30° C. to 500° C.

28. The air or gas treatment system according to claim 22, wherein, the first pipe is intended to feed gas to the vessel during an adsorption process and to receive exhaust from the vessel during a desorption process, the air or gas treatment system further comprising at least a feed pipe and a feed pipe structured adsorbent or catalyst in the feed pipe, the feed pipe being intended to feed gas to the first pipe during an adsorption process and to be kept clear of exhaust during a desorption process, the feed pipe structured adsorbent or catalyst being configured to adsorb or trap at least partially at least one component of gas received by the feed pipe structured adsorbent or catalyst such that, the gas released from the feed pipe structured adsorbent or catalyst has an outgoing composition different from an incoming composition of the gas received by the feed pipe structured adsorbent or catalyst.

29. The air or gas treatment system according to claim 28, wherein, the feed pipe structured adsorbent or catalyst is configured to adsorb or trap trace contaminants.

30. The air or gas treatment system according to claim 22, wherein, the pressure drop across the structured adsorbent or catalyst and/or the feed pipe structured adsorbent or catalyst if present is lower than 500 mbar absolute.

31. The air or gas treatment system according to claim 22, wherein, the structured adsorbent or catalyst occupies the entire cross-section of the first pipe and/or the feed pipe structured adsorbent or catalyst if present occupies the entire cross-section of the feed pipe.

32. The air or gas treatment system according to claim 22, wherein, the structured adsorbent or catalyst and/or the feed pipe structured adsorbent or catalyst if present consists of an active adsorbent material directly extruded in the required structural form, or has a film of active adsorbent material deposited or grown on a surface of a support structure.

33. The air or gas treatment system according to claim 32, wherein, the active adsorbent material comprises at least one of the following: metal-organic frameworks, carbon materials, resins and polymers, clays, silica gel, activated alumina, natural or synthetic zeolites.

34. The air or gas treatment system according to claim 22, wherein, the structured adsorbent or catalyst is the form of foams, fabric, monoliths, or laminates.

35. The air or gas treatment system according to claim 22, wherein, the structured adsorbent or catalyst and/or the feed pipe structured adsorbent or catalyst if present comprises a support comprising corrugated paper or honeycomb structure, or paper monolith, or cordierite monolith, or honeycomb monolith, or honeycomb rotary adsorber, or activated carbon cloth, or charcoal cloth, or self-supporting adsorbent fabric, or multi-layered adsorbent fabric, or paper honeycomb, or copper foam, or ceramic foam, or parallel passage laminate, or adsorbent laminate, or spirally wound laminate, or activated carbon honeycomb monolith, or polyamide monolith, or carbon monolith, or monolithic wheel, or ceramic monolith, or zeolite monolith, or metal monolith, or inherent adsorbent monolith, or inherent adsorbent honeycomb monolith, or inherent adsorbent foam, or inherent adsorbent cloth.

36. The air or gas treatment system according to claim 22, wherein, the first pipe and/or the feed pipe if present has a diameter between 9 mm and 2000 mm.

37. The air or gas treatment system according to claim 22, wherein, the adsorbent or catalyst in the vessel is in the form of beads, pellets, foams, fabric, monoliths, or laminates.

38. The air or gas treatment system according to claim 22, wherein, the adsorbent or catalyst in the vessel comprises at least one layer of metal-organic frameworks or, carbon materials or, resins and polymers or, clays or, silica gel or, activated alumina or, natural or synthetic zeolites.

39. The air or gas treatment system according to claim 22, wherein, the adsorbent or catalyst in the vessel adsorbs or traps at least partially carbon dioxide and/or moisture and/or nitrogen and/or oxygen and/or argon and/or hydrogen and/or hydrogen sulphide and/or mercaptans and/or paraffins, and/or acid gases, and/or silanes, and/or mercury vapor, and/or hydrocarbons, and/or trace contaminants in air or gas.

40. The air or gas treatment system according to claim 22, wherein, the vessel is configured to receive gas having a pressure between 1.1 bar absolute and 30 bar absolute.

41. The air or gas treatment system according to claim 22, wherein, the passage has a diameter between 49 mm and 3000 mm.

42. The air or gas treatment system according to claim 22, wherein, the gas released and/or received by the vessel has a flux between 0.1Nm ³ /h and 16000 Nm³ /h.
